(19) United States
(12) Patent Application Publication
(10) Pub. No.: US 2005/0004712 A1
(43) Pub. Date: Jan. 6, 2005

(54) Method and apparatus for determining time remaining for hot water flow

(76) Inventors: Jeffrey W. Stevens, Albuquerque, NM (US); Richard H. Cottrell, Rio Rancho, NM (US)

Correspondence Address: Andrea L. Mays, Esq.;Law Office of Andrea L. Mays, Post Office Box 1337, Placitas, NM, 87043-1337, US

(21) Appl. No.: 10/614,624

(22) Filed: Jul. 5, 2003

(51) Int. Cl. G05B 21/00

(52) U.S. Cl. 700/266

(57) ABSTRACT

A method and apparatus for determining time remaining for hot water flow at a particular temperature. A first, water outlet sensor system 22 is located near a water outlet such that temperature sensor 24 senses the water temperature of water flowing to a water outlet 14. A second, water heater sensor system 34 is located near a water heater storage vessel 18 for sensing the water temperature of water exiting the storage vessel 18. Water heater sensor system 34 includes a logic controller 38 for determining time remaining for hot water flow based upon sensed temperatures at water outlet 14 and storage vessel 18. Display device 42 provides information received from controller 38 and from water outlet sensor system 22. First and second sensor systems 22, 34 and display device 42 communicate via radio frequency communication link 29.

### BACKGROUND OF THE INVENTION

1. Field of the Invention (Technical Field)

The present invention relates generally to the field of hot water supply devices and water temperature measurement devices, and particularly to a method and apparatus for determining the remaining amount of time for maintaining a flow of hot water at a particular temperature from a hot water supply storage vessel.

2. Background Art

Apparatuses and methods are known for the control of fluid flow through plumbing into a structure such as a residence, building, or other facility. Conventional water outlet fixtures, such as faucets, shower-heads, garden hose couplings and the like are commonly used to access water for drinking, washing, and bathing within structures and without. A water heater having a heating element or elements to heat the water and an associated supply vessel for containment and storage of the heated water conventionally provides the hot water supply for a structure. Temperature and volume flow of the water exiting a water outlet are typically controlled through independent, manual adjustment of knobs mechanically coupled to ball valves in plumbing hot and cold water lines respectively.

Various automated mixing devices are known for controlling the ratio of hot to cold water exiting through a faucet to achieve a constant preset temperature, some of which also control the flow volume of water. Such devices alleviate or decrease the need for the user to continually adjust the knobs controlling the hot and cold water lines. Examples of these devices can be found in U.S. Pat. No. 4,682,728 to Oudenhoven et al., entitled, “Method and Apparatus for Controlling the Temperature and Flow Rate of a Fluid;” U.S. Pat. No. 6,029,094 to Diffut, entitled, “Shower Temperature and Flow Rate Memory Controller;” U.S. Pat. No. 6,059,192 to Zosimadis, entitled, “Wireless Temperature Monitoring System;” U.S. Pat. No. Re 35,018 to Homan, entitled, “Bath Water Control System;” and U.S. Pat. No. 6,286,764 to Garvey et al., entitled, “Fluid and Gas Supply System.”

One difficulty in particular with hot water heaters is that they maintain a finite volume of hot water. As hot water is depleted from the heater into the structure, the hot water heater typically cannot heat additional water at a rate that is fast enough to replace the depleted hot water. Accordingly, the amount of hot water that can be delivered through the plumbing of a structure is limited in time by the volume that is contained in the water heater storage vessel and the flow rate of the hot water from the faucet. The result of having a finite supply of hot water is that a person who is showering, for example, may find themselves subjected to increasingly colder water during the time period of their shower. Additionally, if the hot water supply was significantly diminished prior to the person taking a shower, due to prior use of the shower or other activity requiring hot water, the person may experience only a few minutes or less of hot water leading to an uncomfortably cold bathing experience.

There are a multitude of situations whereby exposure to decreasing water temperatures is an impediment to the task at hand, or even dangerous, such as in a hospital setting. While the prior art has attempted to address the issues of maintaining a preset water temperature and preset flow volume in an automated fashion, the issue of having only a finite volume of hot water has not been addressed.

It would be ideal if a person in need of hot water could have knowledge of the available hot water supply prior to beginning the task requiring the hot water, such as a shower. In particular, it would be ideal if the person could be informed of the time remaining to maintain a flow of hot water to avoid being caught in a cold and uncomfortable shower. The present invention overcomes the limitations of the prior art by providing a method and apparatus for determining the time remaining for hot water flow at a particular temperature.

### SUMMARY OF THE INVENTION (DISCLOSURE OF THE INVENTION)

The present invention is an apparatus for determining time remaining for fluid flow, such as hot water flow, at a particular temperature from a fluid outlet, which receives fluid from a fluid source. One non-exclusive example of a fluid source includes a hot water heater. A non-exhaustive list of fluid outlets includes water outlets, such as showerheads, faucets, and garden hose water outlets. The inventive apparatus includes a first temperature sensor which senses fluid temperature at a fluid outlet, a second temperature sensor which senses fluid temperature at a fluid source, a communication link, and a controller in communication with the first and second temperature sensors via the communication link. The controller compares sensed fluid temperatures from a fluid outlet and fluid source to determine time remaining for fluid flow at a particular temperature from a fluid outlet. The controller is an EEPROM, microcontroller, microprocessor, or any device of suitable memory capacity, programmability, and processing capability.

The communication link is preferably a wireless communication link, such as a radio frequency communication link. Alternatively, the communication link is a hardwire connection between components.

The temperature sensors can be thermocouples or other suitable temperature sensing devices. Preferably, the temperature sensors are incorporated onto an integrated circuit. The fluid outlet temperature sensor is actually a sensor system consisting of the temperature sensor, a radio frequency transmitter, and power supply mounted on a printed circuit board, and a housing enclosing these components for protection from the environment. This sensor system is affixed to a sleeve for placement in line with fluid flow to a fluid outlet. The sensor component penetrates the sleeve to make contact with the fluid flowing through the sleeve.

The fluid source temperature sensor is also a sensor system consisting of a temperature sensor, radio frequency transceiver, and power supply mounted upon a printed circuit board. A housing encloses the temperature sensor, radio frequency transceiver, and power supply for protection from the environment. Preferably, the controller is also enclosed within this housing.

The inventive apparatus further includes a display device for relaying information to a user. This information includes the time remaining for fluid flow at a particular temperature from a fluid outlet, as well as the current fluid temperature from a fluid outlet. The display device is in communication with the first temperature sensor at the fluid outlet and the controller in order to obtain this information for display. The display device includes a display, a radio frequency transceiver, and a power supply. Optionally, the display device includes an audio device for providing auditory information to a user.

The present invention is further a method of determining time remaining for fluid flow at a temperature from a fluid outlet which receives fluid from a fluid source. The method includes providing temperature sensors at a fluid outlet and fluid source, providing a controller, sensing fluid temperature at the fluid outlet and fluid source, communicating sensed fluid temperatures to the controller, and determining time remaining for fluid flow at a particular temperature from the fluid outlet with the controller based upon sensed fluid temperatures.

Communicating sensed fluid temperatures to the controller includes communicating sensed fluid temperatures to the controller via a communication link. The communication link can be a wireless communication link or a hardwire communication link. When communicating sensed fluid temperatures to the controller via a wireless communication link, the inventive method includes sensing temperature at the fluid outlet, converting the sensed temperature to a radio frequency signal, transmitting the radio frequency signal, and receiving the transmitted radio frequency signal at a receiver in communication with the controller.

The inventive method further includes displaying the time remaining for fluid flow at a particular temperature from a fluid outlet on a display. To display the time remaining, the method consists of converting time remaining information from the controller to a radio frequency signal and transmitting the time remaining radio frequency signal to a receiver in communication with a display.

The method also includes displaying the current fluid outlet temperature on a display. This step consists of converting sensed fluid outlet temperature to a radio frequency signal and transmitting the fluid outlet temperature signal to a receiver in communication with a display.

Optionally, the method includes the step of audibly indicating the time remaining for fluid flow at a temperature from a fluid outlet. The audible indicator is preferably located on or near the display device.

The present invention is further a method of determining time remaining for fluid flow at a temperature from a fluid outlet which receives fluid from a fluid source which includes the steps of sensing fluid temperature at a fluid outlet, sensing fluid temperature at a fluid source, comparing at least two sensed fluid temperatures, and determining time remaining for fluid outlet flow at a temperature based upon the comparing step. The comparing step can include subtracting a previously sensed temperature from a later sensed temperature. The comparing step also includes determining a rate of temperature change from at least two sensed fluid source temperatures. Determining time remaining for fluid outlet flow at a temperature is accomplished by comparing a sensed fluid outlet temperature to a sensed fluid source temperature, and determining the time remaining based upon the comparison between a sensed fluid outlet temperature and sensed fluid source temperature and the rate of temperature change.

The present invention is still further a method of determining time remaining for fluid flow at a temperature from a fluid outlet which receives fluid from a fluid source. The method includes providing a fluid outlet fluid temperature, sensing fluid temperature at a fluid source, comparing at least two fluid temperatures, and determining time remaining for fluid outlet flow at a temperature based upon the comparing step.

A primary object of the present invention is to provide a method and apparatus for determining the time remaining for hot water flow from a water outlet at a particular temperature.

A primary advantage of the present invention is that it provides useful information to a user of hot water from a finite hot water supply vessel regarding the time remaining for hot water flow at a particular temperature. Another primary advantage of the present invention is that it is simple and inexpensive. Still another primary advantage of the present invention is that it is easy to install on conventional plumbing fixtures and hot water supply equipment. Yet another primary advantage of the present invention is that it aids in the prevention of uncomfortable or dangerous exposure to decreasing water temperatures.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate a preferred embodiment of the present invention and, together with the description, serve to explain the principles of the invention. The drawings are not to be construed as limiting the invention.

FIG. 1 is a schematic diagram of the preferred embodiment of the apparatus of the present invention for determining and indicating the time remaining for hot water flow at a particular temperature;

FIG. 2A is a side-view diagram of a water outlet sensor system configuration installed at the water outlet in accordance with the present invention;

FIG. 2B is a cross-section of the water outlet sensor system and associated mounting sleeve of FIG. 2A;

FIG. 3 is a front view of a preferred embodiment of the display device of the present invention; and

FIGS. 4A and 4B in conjunction are a diagrammatic representation of the operation of the present invention for determining and indicating the time remaining for hot water flow at a particular temperature.

### DESCRIPTION OF THE PREFERRED EMBODIMENTS

### Best Modes for Carrying Out The Invention

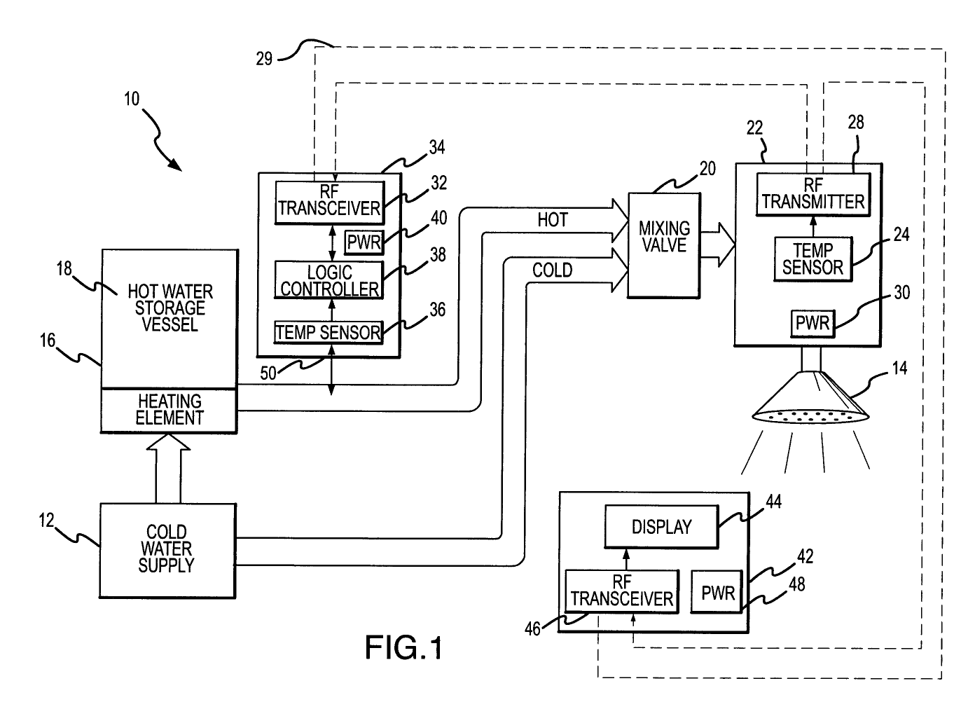

Referring to FIG. 1, a schematic diagram of the preferred embodiment of the apparatus of the present invention 10 for determining and indicating the remaining amount of time for hot water flow at a particular temperature is shown. The apparatus of the invention is discussed first and is followed by a discussion of system operation.

Cold water supply 12 is shown in fluid communication with a fluid outlet 14, such as a showerhead or other water outlet. Cold water supply 12 is also in fluid communication with water heater 16 which provides a heating element for heating cold water that is input to water heater 16. Water heater 16 includes a hot water storage vessel 18 for containment of the heated water. Hot water from vessel 18 is in fluid communication with water outlet 14 along with cold water from supply 12. Hot and cold water from the fluid sources, namely storage vessel 18 and cold water supply 12, are mixed by conventional means 20, typically being manually controlled ball valves in the plumbing that adjust the ratio of hot to cold water allowed to exit from water outlet 14.

A water outlet sensor system 22 is in communication with water exiting from water outlet 14. Sensor system 22 contains water temperature sensor 24, radio frequency (RF) transmitter 28 and power supply 30, preferably mounted upon a printed circuit board (PCB) and enclosed in an appropriate housing suited to protecting the components from the environment. Water outlet sensor system 22 receives power from power supply 30 which can be, but is not limited to, a battery or batteries of suitable voltage and current capability. A variety of temperature sensor devices 24 are suitable for the purpose of measuring the temperature of the water exiting from water outlet 14. Any sensor that provides a proportional voltage output in relation to measured temperature is appropriate. One example of such a device includes the integrated circuit temperature sensors manufactured by Dallas MicroChips, Inc. These devices sense temperature and convert the sensed information into an appropriate digital signal output representative of temperature.

The output from temperature sensor 24 is input to RF transmitter 28. RF transmitter 28 transmits the representative sensed temperature value wirelessly via communication link 29 to be received by RF transceiver 32 of water heater sensor system 34, and RF transceiver 46 of display device 42. This temperature is displayed as the current water outlet temperature on display 44.

Water heater sensor system 34 includes water temperature sensor 36 that is in communication with hot water storage vessel 18, RF transceiver 32, logic controller 38 and power supply 40, preferably mounted upon a PCB and enclosed in an appropriate housing suited to protecting the components from the environment. Temperature sensor 36 senses the temperature of the water exiting storage vessel 18 preferably by way of a conventional self-piercing valve 50 containing a thermocouple wire. Self-piercing valves enable a pipe to be spliced or jointed without cutting the original pipe. Self-piercing valve 50 consists primarily of a needle that is used to pierce the pipe and gain access to the interior of the pipe, and a self-sealing gasket that seals the opening around the needle. Self-piercing valve 50 is preferably mounted on the plumbing apparatus in fluid communication with storage vessel 18 such that the thermocouple wire makes contact with the water within. Alternatively, a heat-conductive material having a thermocouple mounted thereto is in thermal communication with the plumbing from storage vessel 18 to sense water temperature externally without piercing the plumbing apparatus. One such apparatus is a heat conductive metal sleeve that is arranged around the pipe that channels hot water from storage vessel 18 in order to conduct heat from the pipe to the thermocouple.

It will of course be understood by those of skill in the art that temperature sensor 36 can be placed at a variety of locations in the proximity of storage vessel 18 for the purpose of generating a representative temperature of the water within storage vessel 18. A variety of temperature sensor devices are suitable for the purpose of representing the temperature of the hot water storage vessel 18, including the integrated circuit temperature sensors manufactured by Dallas MicroChips, Inc.

The output from temperature sensor 36 is input to logic controller 38 which stores and determines the time remaining for hot water flow. Power supply 40 provides power to sensor system 34. Power supply 40 can consist of a battery or batteries, or other electrical supply means, of suitable voltage and current capability.

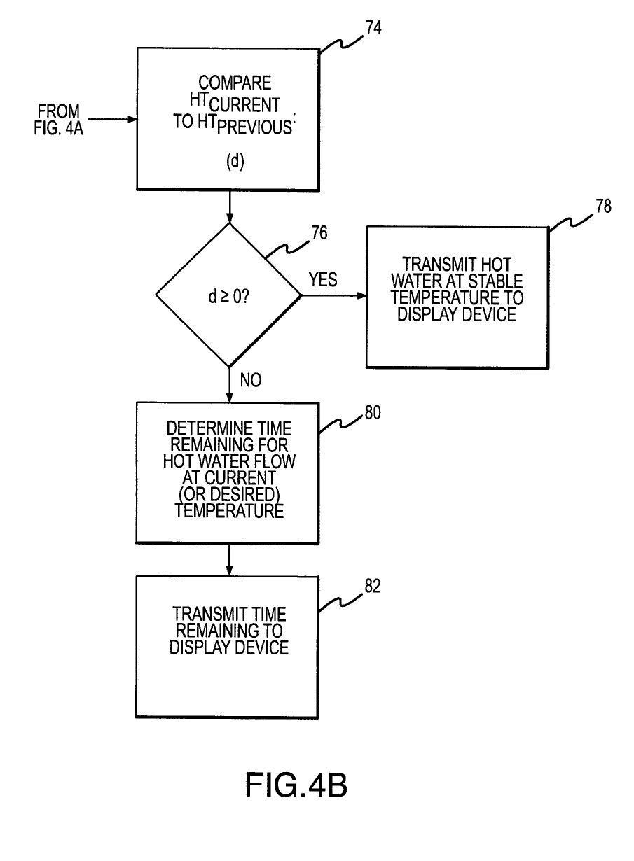

In addition to receiving the output of temperature sensor 36 which measures the temperature of the hot water at storage vessel 18, logic controller 38 also receives from RF transceiver 32 the transmitted temperature value from RF transmitter 28 that is representative of the water temperature at water outlet 14. Temperature values received from temperature sensor 36 and temperature sensor 24 are used by logic controller 38 to determine the time remaining for a flow of hot water from water outlet 14, as discussed below with reference to FIGS. 4A and 4B.

Logic controller 38 can be, but is not limited to, a conventional electrically erasable programmable read-only memory (EEPROM) device. Other devices that can perform the functions of logic controller 38 include a variety of microcontrollers and microprocessors, of suitable memory capacity, programmability, and processing capability. It will be understood by those of skill in the art that a variety of programmable devices can be implemented in accordance with the principles of the invention for the purpose of determining desired parameters according to inputs received from sensing devices.

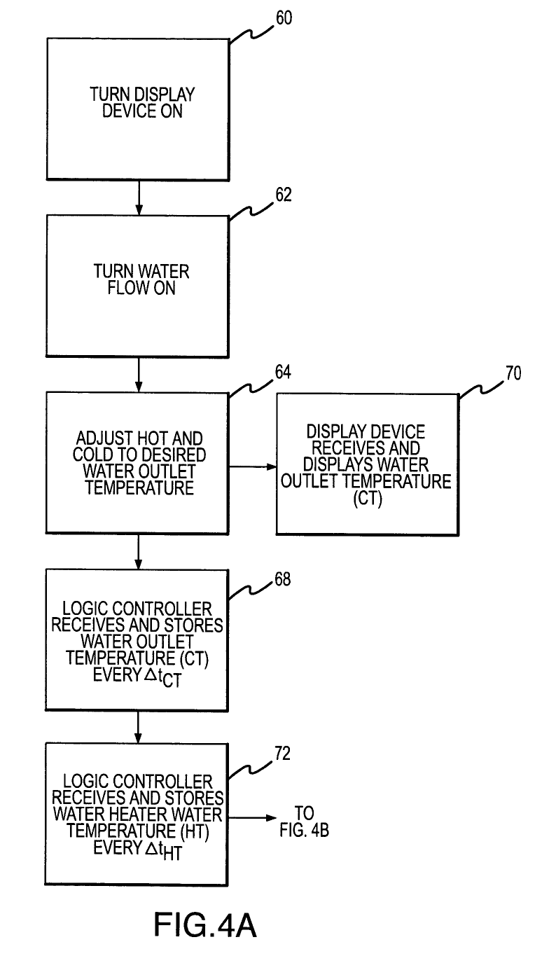

Display device 42 provides a display to the user of the time remaining for hot water flow at the current temperature as well as the current temperature of the water at water outlet 14. (See also FIG. 3.) Display device 42 includes display 44, such as a light emitting diode (LED) display, liquid crystal display (LCD), or other suitable display, and the associated electronics required for operating display 44. Display device 42 also includes user interface electronics, power supply 48 and RF transceiver 46. These components are preferably mounted upon a PCB and enclosed in an appropriate housing suited to protecting the components from the environment.

RF transceiver 46 receives the time remaining information via wireless transmission over communication link 29 from RF transceiver 32, which transmits the information from logic controller 38. RF transceiver 46 receives the current water outlet temperature information from RF transmitter 28 over communication link 29. The information is communicated from RF transceiver 46 to display 44 for display to the user. RF transceiver 46 also transmits information input by the display device user to logic controller 38, such as desired temperature, discussed with reference to FIGS. 3 and 4 below. Power supply 48, such as a battery, provides power to all components of display device 42.

The preferred embodiment of the present invention incorporates RF transmission between water outlet sensor system 22, water heater sensor system 34 and display device 42 via communication link 29 which simplifies installation of the apparatus. However, in an alternative embodiment, water outlet sensor system 22, water heater sensor system 34 and display device 42 are in communication via an electrical hardwire connection. In this embodiment, RF transmitter 28, RF transceiver 32 and RF transceiver 46 are not necessary and are replaced by conventional input/output mechanisms and electronics necessary for communicating information between components. In this embodiment, communication link 29 consists of suitable wiring connecting the various components.

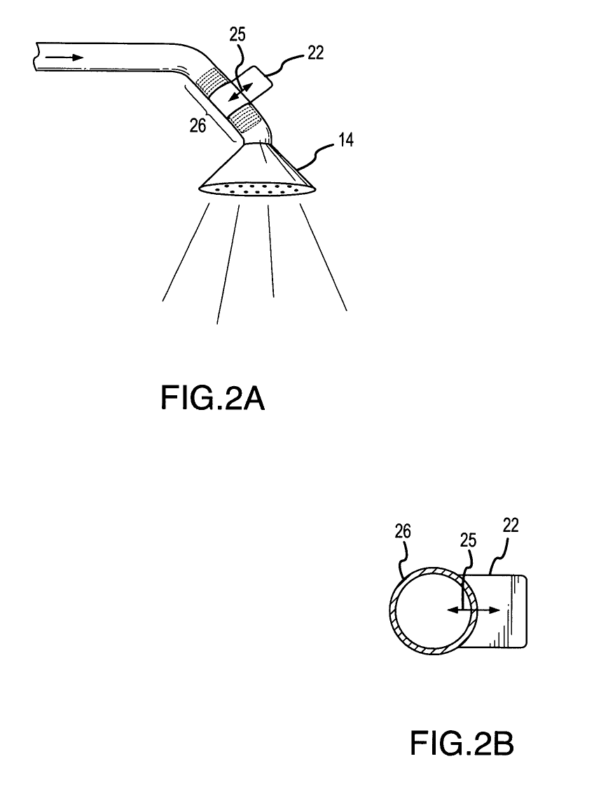

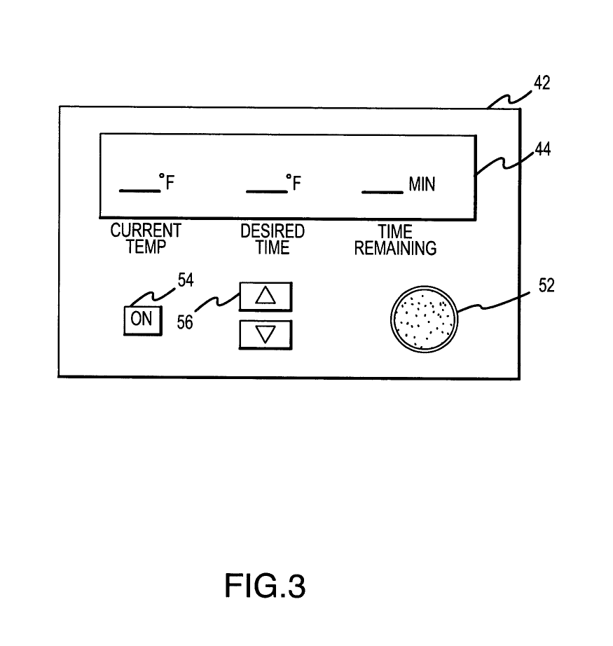

Referring to FIG. 2A, a side view of water outlet sensor system 22 in communication with water flow to water outlet 14 is shown. Sensor system 22 is affixed to cylindrical sleeve 26 for placement in line with fluid flow from the water supply line to water outlet 14. Sleeve 26 is preferably threaded at opposing ends for ease of installation in conventional water outlet configurations, such as immediately preceding a showerhead. FIG. 2B provides a top view of sensor system 22 and associated sleeve 26 of FIG. 2A. Preferably sensor system 22 and cylindrical sleeve 26 are an integral unit made of a sufficiently robust material, such as a rigid pre-molded plastic. Thermocouple wire 25 of temperature sensor 24 extends from sensor system 22 through a small, sealable opening into sleeve 26 thereby contacting the water flowing through sleeve 26. With modification to the dimensions and thread configuration of sleeve 26, sleeve 26 and associated sensor system 22 are adaptable for placement at a conventional water faucet or garden hose water outlet.

Referring to FIG. 3, an exterior front view of display device 42 is shown. (See also FIG. 1) Display device 42 includes display 44 for communicating visual information to a user, as well as power switch 54 to enable and disable the display device 42, and optionally an audio device 52, such as a speaker, for providing auditory information to a user. Display 44 reveals the current water temperature as determined by temperature sensor 24 located at water outlet 14, and the time remaining for hot water flow at the current temperature.

User interface buttons 56 are provided so that the user can input a desired water temperature, either higher or lower than the current temperature. The desired temperature value is then transmitted by transceiver 46 to logic controller 38 to be used in determining time remaining for hot water flow at the desired temperature. Therefore, the user can determine whether an increase or decrease in water temperature may shorten or lengthen the duration of the remaining hot water supply. This determination is useful prior to adjustment of the hot and cold water valves.

Referring in combination to FIGS. 4A and 4B, the methodology for operation of system 10 is shown. First, display device 42 is turned on, 60, via power switch 54, and water outlet 14 is turned on, 62. (See also FIGS. 1 and 3.) Next, the user manually adjusts the hot and cold water to the desired temperature, 64. During this process temperature sensor 24 senses the water temperature at water outlet 14 and this information is transmitted to logic controller 38 of water heater sensor system 34. Logic controller 38 samples this information, receiving and storing it as the “current temperature” (CT) value for water outlet 14 at preprogrammed time intervals, Δt_{CT}, 68, where Δt_{CT} preferably does not exceed ten seconds. Current temperature from sensor 24 is also transmitted from RF transmitter 28 to RF transceiver 46 for display as the “current temperature” on the display, 70. The current temperature is continuously updated on display 44 as the information is received from temperature sensor 24.

Logic controller 38 also samples the water heater storage vessel temperature, receiving and storing water heater storage vessel temperature (HT) values from temperature sensor 36 at preprogrammed time intervals, Δt_{HT}, for example, every five seconds, 72. Preferably Δt_{HT} does not exceed ten seconds. Logic controller 38 compares the current hot water heater temperature (HT_{current}) to the previous hot water heater temperature (HTₚᵣₑᵥᵢₒᵤₛ), taken Δt_{HT}earlier, 74, (FIG. 4B) to determine whether the water heater is maintaining the water temperature or unable to maintain the hot water temperature:
HT_{current}−HTₚᵣₑᵥᵢₒᵤₛ=d, (1)
where d is the change in hot water heater temperature over Δt_{HT} seconds. Next, it is determined whether d is a positive value, zero, or negative value, 76. If d is equal to or greater than zero, then the hot water supply is being adequately maintained and the remaining time for hot water flow is infinite. In that circumstance, logic controller 38 transmits information to display device 42 for display of a message on the display, 78, such as “hot water at stable temperature.”

If d is less than zero, then the hot water supply is depleting. In that circumstance, the time remaining for hot water flow at the “current temperature” (CT) is determined, 80. First, the rate of change (r) of the water heater temperature is determined:

$$\frac{d}{Δ {t}_{HT}} = r . \qquad ( 2 )$$

Then the time remaining (TR) for hot water flow at the “current temperature” (CT) is determined:

$$\frac{( CT - {HT}_{current} )}{r} = TR . \qquad ( 3 )$$

Once the time remaining is determined, it is transmitted to display device 42 for display to the user, 82. Equations (1), (2) and (3) assume a homogenous water temperature throughout the volume of water exiting water storage vessel 18 and a constant cold water temperature of the water provided by cold water supply 12.

If the user has input a “desired” water temperature via user interface 56 (see FIG. 3), similar calculations are made by logic controller 38 to determine time remaining (TR) based upon the desired temperature (DT) input by the user instead of current temperature (CT). By inputting a desired temperature, the user can view the time remaining for hot water flow at the desired temperature, prior to manually adjusting the water temperature up or down.

In addition to displaying the time remaining for hot water flow, display device 42 can optionally be configured to provide an audio signal to the user to indicate a depleting hot water supply via audio device 52. Optionally, additional information is displayed via display device 42, for example, Fahrenheit or Celsius temperature values. The amount of information communicated to the user and the manner of communicating the information is limited only by the capabilities of logic controller 38, and the size and sophistication of display device 42, as will be apparent to those of skill in the art.

Optionally, logic controller 38 of the present invention additionally interacts with a mechanized water-mixing valve for automated control of water temperature and flow volume. When configured in this manner, display device 42 additionally provides a flow volume control interface through which the user may input whether to increase or decrease water flow. This information is transmitted to logic controller 38 which then provides signals to a mechanized mixing valve. Similarly, desired temperature input by the user is transmitted to logic controller 38 which directs the mechanized valve to adjust the hot to cold water ratio prior to the water outlet. A variety of mechanized valves and means for control of such valves are known to those of skill in the art.

Although application of the present invention is depicted in FIGS. 1 through 4 on a single water outlet 14, the present invention can be installed for operation in conjunction with a plurality of water outlets. For example, with water heater sensor system 34 installed at water heater 16, a plurality of water outlet sensor systems 22 can be installed at a variety of water outlets throughout a structure, such as at a kitchen sink water outlet, shower head, and garden hose water outlet. A corresponding display device 42 is installed at each of these water outlets as well. In this configuration, RF transmission between the respective water outlet sensor systems, display devices, and water heater sensor system 34 is modified such that each water outlet operates at a different radio frequency. In this manner, logic controller 38 provides the information appropriate to each water outlet.

Although the invention has been described in detail with reference to these preferred embodiments, other embodiments can achieve the same results. Variations and modifications of the present invention will be obvious to those skilled in the art and it is intended to cover in the appended claims all such modifications and equivalents.

1. An apparatus for determining time remaining for fluid flow at a temperature from a fluid outlet [14] which receives fluid from a fluid source [18], comprising:
a first temperature sensor [22] for sensing fluid temperature at a fluid outlet [14];
a second temperature sensor [34] for sensing fluid temperature at a fluid source [18];
a communication link [29]; and
a controller [38] in communication with said first temperature sensor [22] and said second temperature sensor [34] via said communication link [29], for comparing sensed fluid temperatures to determine time remaining for fluid flow at a temperature.

2. The apparatus of claim 1 wherein said communication link [29] comprises a wireless communication link.

3. The apparatus of claim 2 wherein said wireless communication link [29] comprises a radio frequency communication link.

4. The apparatus of claim 1 wherein said communication link [29] comprises a hardwire communication link.

5. The apparatus of claim 1 wherein said first temperature sensor [22] comprises an integrated circuit temperature sensor [22].

6. The apparatus of claim 1 wherein said first temperature sensor [22] comprises a thermocouple.

7. The apparatus of claim 1 wherein said first temperature sensor [22] comprises a sensor system comprising [22]:
a temperature sensor [24];
a radio frequency transmitter [28];
a power supply [30]; and
a housing enclosing said temperature sensor [24], radio frequency transmitter [28], and power supply [30] for protection from the environment.

8. The apparatus of claim 7 wherein said sensor system [22] further comprises a sleeve [26] for placement in line with fluid flow to a fluid outlet.

9. The apparatus of claim 1 wherein said second temperature sensor [34] comprises an integrated circuit temperature sensor.

10. The apparatus of claim 1 wherein said second temperature sensor [34] comprises a thermocouple.

11. The apparatus of claim 1 wherein said second temperature sensor [34] comprises a sensor system comprising:
a temperature sensor [36];
a radio frequency transceiver [32];
a power supply [40]; and
a housing enclosing said temperature sensor [36], radio frequency transceiver [32], and power supply [40] for protection from the environment.

12. The apparatus of claim 1 further comprising a display device [42] for relaying information to a user.

13. The apparatus of claim 12 wherein said display device [42] is in communication with said first temperature sensor [22] and said controller [38].

14. The apparatus of claim 13 wherein said display device [42] comprises:
a display [44];
a radio frequency transceiver [46]; and
a power supply [48].

15. The apparatus of claim 12 wherein said display device [42] comprises an audio device [52].

16. The apparatus of claim 1 wherein said controller [38] comprises a device selected from the group consisting of EEPROMs, microcontrollers, and microprocessors.

17. A method of determining time remaining for fluid flow at a temperature from a fluid outlet [14] which receives fluid from a fluid source [18], the method comprising:
providing temperature sensors [22, 34] at a fluid outlet [14] and fluid source [18];
providing a controller [38];
sensing fluid temperature at the fluid outlet [14] and fluid source [18];
communicating sensed fluid temperatures to the controller [38]; and
determining time remaining for fluid flow at a temperature from the fluid outlet [14] with the controller [38] based upon the sensed fluid temperatures.

18. The method of claim 17 wherein the step of communicating sensed fluid temperatures to the controller [38] comprises communicating sensed fluid temperatures to the controller [38] via a communication link selected from the group consisting of wireless communication links [29] and hardwire communication links [29].

19. The method of claim 18 wherein the step of communicating sensed fluid temperatures to the controller [38] via a wireless communication link [29] comprises:
sensing temperature at the fluid outlet [14];
converting the sensed temperature to a radio frequency signal [28];
transmitting the radio frequency signal [28]; and
receiving the transmitted radio frequency signal at a receiver [32] in communication with the controller [38].

20. The method of claim 17 further comprising the step of displaying time remaining for fluid flow at a temperature from a fluid outlet [14] on a display [44] [see step 82].

21. The method of claim 20 wherein the step of displaying time remaining for fluid flow at a temperature from a fluid outlet [14] on a display comprises:
converting time remaining information from the controller [38] to a radio frequency signal [32]; and
transmitting the time remaining radio frequency signal [32] to a receiver [46] in communication with a display [44].

22. The method of claim 17 further comprising the step of displaying fluid outlet [14] temperature on a display [44] [see step 70].

23. The method of claim 22 wherein the step of displaying fluid outlet [14] temperature on a display [44] comprises:
converting sensed fluid outlet temperature to a radio frequency signal [28]; and
transmitting the fluid outlet temperature signal to a receiver [46] in communication with a display [44].

24. The method of claim 17 further comprising the step of audibly indicating [52] the time remaining for fluid flow at a temperature from a fluid outlet [14].

25. A method of determining time remaining for fluid flow at a temperature from a fluid outlet [14] which receives fluid from a fluid source [18], the method comprising:
sensing fluid temperature at a fluid outlet [68];
sensing fluid temperature at a fluid source [72];
comparing at least two sensed fluid temperatures [74, 76, 80, Eqns. 1, 2, 3]; and
determining time remaining for fluid outlet flow at a temperature based upon the comparing step [80, Eqn. 3].

26. The method of claim 25 wherein the step of comparing at least two sensed fluid temperatures comprises subtracting a previously sensed temperature from a later sensed temperature [74, Eqn. 1].

27. The method of claim 25 wherein the step of comparing at least two sensed fluid temperatures comprises determining a rate of temperature change[Eqn. 2] from at least two sensed fluid source temperatures.

28. The method of claim 27 wherein the step of determining time remaining [80, Eqn. 3] for fluid outlet flow at a temperature comprises:
comparing a sensed fluid outlet temperature to a sensed fluid source temperature [Eqn. 3 numerator]; and
determining time remaining for fluid outlet flow at a temperature based upon the comparison between a sensed fluid outlet temperature and sensed fluid source temperature [Eqn. 3 numerator] and the rate of temperature change [Eqn. 2 and Eqn. 3 denominator].

29. A method of determining time remaining for fluid flow at a temperature from a fluid outlet which receives fluid from a fluid source, the method comprising:
providing a fluid outlet fluid temperature [CT or DT];
sensing fluid temperature at a fluid source [72];
comparing at least two fluid temperatures [74, 76, 80, Eqns. 1, 2, 3, using CT or DT]; and
determining time remaining for fluid outlet flow at a temperature based upon the comparing step [80, Eqn. 3].
